(19) United States
(12) Patent Application Publication
(10) Pub. No.: US 2002/0198307 A1
(43) Pub. Date: Dec. 26, 2002

(54) Low intrinsic viscosity drop, low acetaldehyde, polyesters

(76) Inventor: Rajesh Jalan, Purwakarta (ID)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/207,324

(22) Filed: Jul. 29, 2002

Related U.S. Application Data
(63) Continuation-in-part of application No. 09/426,401, filed on Oct. 25, 1999.

(51) Int. Cl. B32B 1/02; C08K 3/34

(52) U.S. Cl. 524/493; 428/35.7; 428/910; 524/492

(57) ABSTRACT

The low intrinsic viscosity drop, low acetaldehyde, polyester composition of the invention typically produce packaging materials such as bottles. The polyester, generally PET, uses additives such as fumed silicon dioxide. The additives are added in small amounts for achieving the following benefits: (i) lower I.V. (intrinsic viscosity) drop during the injection molding process; (ii) lower levels of acetaldehyde in the resultant preforms/bottles. These properties are achieved without affecting strain-hardening properties during the stretch-blow molding operation; and without affecting anti-blemishness properties in the final bottles. These additives alone or in conjunction with carbon black provide the faster line speeds that production needs.

This patent application is a continuation-in-part of patent application Ser. No. 09/426,401 filed Oct. 25, 1999.

### TECHNICAL FIELD

This invention relates to low intrinsic viscosity drop, low acetaldehyde, polyester compositions for producing packaging material such as bottles. More specifically, the polyesters contain additives such as fumed silicon dioxide.

### BACKGROUND OF THE INVENTION

Polyethylene terephthalate is a polyester useful in preparing molded bottles to contain a wide variety of commercial liquids. The industry desires that the bottles have excellent strength and a high degree of clarity. The hollow blow molded thermoplastic, such as a thermoplastic polyester or a biaxially oriented polyethylene terephthalate resin, “PET”, container, is commonly used to contain food or beverage, has excellent physical properties, durability and a wide range of applications.

Heretofore, various compounds and catalysts have been used in the preparation of polyesters. Industry demands low intrinsic viscosity drop, low acetaldehyde, high clarity, neutral hue and low haze value that upon the normal reheat of a parison used in the blow molding of a polyester bottle, normal molding temperatures and the usual residence times will produce acceptable bottles. Industry, however, has had difficulty in providing the low intrinsic viscosity drop and low acetaldehyde, polyesters.

Industry continues to demand faster production speeds and improved heat rate, yet maintain the low intrinsic viscosity drop, low acetaldehyde, high clarity, neutral hue and low haze values of the polyester. In the past, production has used low levels of amorphous silicon dioxide to provide polyester bottles having a low tendency to stick together during and after molding. The bottles also have a reduced tendency to stick to other bottles during packing and transportation. The amorphous silicon dioxide is a non-crystalline silicon dioxide typically produced from a sol-gel process.

### BRIEF SUMMARY OF THE INVENTION

This invention is a low intrinsic viscosity drop, low acetaldehyde, polyester composition for producing packaging material such as bottles. The polyester contains additives of fumed silicon dioxide, calcium carbonate or barium sulfate. These additives are added in small amounts for achieving the following benefits:

i) Lower I.V. (Intrinsic Viscosity) drop during the injection molding process.

ii) Lower levels of acetaldehyde in the resultant preforms/bottles.

I have achieved these properties without affecting the strain-hardening properties during the stretch-blow molding operation and without affecting the anti-blemishness in the final bottles.

These additives provide the faster line speeds that production needs. While the addition of carbon black in small quantities in the polyester resin for improving infrared absorption is already known, the further addition of fumed silicon dioxide and/or other additives additionally increases the infrared absorption of the polyester resin without worsening its color as happens with just the addition of carbon black.

### DETAILED DESCRIPTION OF THE INVENTION

Generally, the low intrinsic viscosity drop, low acetaldehyde, high clarity, low haze polyester composition of this invention has a low intrinsic viscosity drop and low acetaldehyde levels. Preferably, the additive is fumed silicon dioxide. Typically, the polyester contains an amount of additive ranging from 1 to 5000 ppm. Preferably, the amount of additive ranges from 10 to 1000 ppm. More preferably, the amount of additive ranges from 10 to less than 100 ppm. Another embodiment, ranges from 50 to less than 100 ppm.

Typically, the additive is fumed amorphous or crystalline silicon dioxide powder. Preferably, the additive is fumed amorphous silicon dioxide powder. More preferably, the additive is amorphous fume grade silicon dioxide powder. The particle size of such silicon dioxide powder ranges from 0.1 to 0.2 micron. Another embodiment ranges from greater than 0.1 to less than 0.2 micron.

The silica is produced by the hydrolysis of chlorosilanes such as silicon tetrachloride vapor in a flame of hydrogen and oxygen. In the combustion process, molten spheres of silica are formed. The diameters of the silica spheres are varied through process changes from an average of 7 to 21 nanometers. These molten spheres, termed primary particles, collide and fuse with one another to form branched three-dimensional, chain-like aggregates. As the aggregates cool below the fusion temperature of silica (approximately 1710° C.), further collisions results in some reversible mechanical entanglements or agglomeration. Further agglomeration also takes place in the collection process. This entire production process is known as thermal or flame or pyrogenic process and the product is fumed silica.

Sol-Gel silica is produced by wet process by hydrolysis of alkali silicates. It is mainly a precipitated silica. Overall, the morphology difference allows the fumed silica to be several times more effective than the Sol-Gel with regards to rheology control. Fumed silica is available as Cab-O-Sil from Cabot Corporation and Aerosil® from Dugussa A. G. (Germany).

Generally, the polyester contains a small amount of at least one infrared absorbing material. Preferably, the infrared absorbing material is carbon black. Generally, the amount of infrared absorbing material ranges from 0.1 to 10 ppm. Preferably, the amount of infrared absorbing material ranges from 0.1 to 5 ppm. Generally, the infrared absorbing material has a particle size ranging from 10 to 500 nm.

The major advantages of these additives is the imparting of improved properties to polyester resin used for the manufacture of packaging materials such as bottles. By the addition of novel materials such as silicon dioxide, calcium carbonate and barium sulfate, one or more of these materials provide the following advantages. They reduce I.V. drop in the process of converting the polyester resin chip to preforms. The addition of fumed silicon dioxide provides lower I.V. drops as compared to formulations which do not contain silicon dioxide additive. Lower acetaldehyde levels also result in preforms produced with resin having silicon dioxide additive while converting polyester chips to preforms in injection molding machines. This is done without affecting the strain hardening characteristics of the polyester resin. This leads to material savings in bottles since the required mechanical strength is obtained with lower weight of polyester resin employed in the bottles. Alternatively, at same thickness of bottles, we can achieve better top load and higher burst strength. Bottles with these additives tend to have unaffected anti-blemishness characteristics which are important in uses where bottles are transported in conveyor lines after their production. It results in greater absorption of infrared radiation by addition of the above-mentioned additives in addition to small quantities of carbon black. This overcomes the limitation of carbon black which depresses the color if added in larger concentrations. This makes it possible to further improve the heat-up rates as compared to formulations which rely only on the addition of carbon black.

Generally, the polyester is produced in a conventional manner as from the reaction of a dicarboxylic acid having from 2 to 40 carbon atoms with polyhydric alcohols such as glycols or diols containing from 2 to about 20 carbon atoms. The dicarboxylic acids can be an alkyl having from 2 to 20 carbon atoms, or an aryl, or alkyl substituted aryl containing from 8 to 16 carbon atoms. An alkyl diester having from 4 to 20 carbon atoms or an alkyl substituted aryl diester having from 10 to 20 carbon atoms can also be utilized. Desirably, the diols may contain from 2 to 8 carbon atoms and preferably is ethylene glycol. Moreover, glycol ethers having from 4 to 12 carbon atoms may also be used. Generally, most of the commonly produced polyesters are made from either dimethyl terephthalate or terephthalic acid with ethylene glycol.

The currently preferred aromatic polyester for bottles is ethylene terephthalate, the product of polymerizing terephthalic acid and ethylene glycol. Ethylene terephthalate copolyesters can be prepared by including other diacids and/or diols in the condensation polymerization mixture. Alkylene diols such as 1,3-propanediol or 1,4-butanediol, and aromatic diacids (or alkyl esters thereof) such as isophthalic acid or 2,6-naphthalene dicarboxylic acid can be added to the polymerization reaction mixture to make bottle grade polyethylene terephthalate copolyesters.

Typically, the polyester will be formed into bottle preforms and then into bottles. A “preform” is a formed structure that can be expanded in a mold to form a bottle. The manufacture of preforms and bottles is known in the art and any one of a number of suitable techniques can be used to prepare the preform and bottle.

Generally, polyester bottles are prepared in blow-molding processes carried out by heating the preform above the polyester glass transition temperature, placing the heated preform into a mold of the desired bottle form, injecting air into the mold to force the preform into the shape of the mold and ejecting the molded bottle.

The polyester for the preforms and bottles preferably is prepared by reacting a dicarboxylic acid(s) (or esters) and diol(s) under condensation polymerization conditions. This generally is done in the presence of a polycondensation catalyst such as antimony trioxide or an organomagnesium at an elevated temperature and in a reduced pressure environment. The process then adds the desired amount of fumed silica and carbon black to the condensation reaction mixture. The reaction generally is carried out to the point at which the reaction product can be easily pelletized. Then the reaction product is extruded in the desired pellet, cube, chip or other small particle forms.

The fumed silica and carbon black may be added during any stage of the polyester preparation such as the esterification, the transesterification stage, or the condensation stage. In the case of making powdered resins the additives may be added at the compounding state or any subsequent master batch route.

In another embodiment, I have found that quick heating by carbon black in a biaxially oriented polyester film, would enhance the rate of heating and cooling of the film. This improves the productivity of any film manufacturing line. Various other films would benefit from the quick heating by carbon black Beside oriented PET films, these include orientable polyethylenes such as linear low density polyethylene (LLDPE), linear medium density polyethylene (LMDPE), high density polyethylene (HDPE), and ultra low density linear polyethylene (ULDLPE), and blends of any two or more of such orientable polyethylenes.

Other orientable films include thermoplastic polyurethane elastomers which are basically diisocynates and short chain diols or long chain diols.

Another type of film is a polyamide thermoplastic elastomer. These thermoplastic polyamide elastomers are polyamide, polyether, polyester or polyetherester blocks, as well as their segment lengths.

Still another type of oriented film is a polymer/polymer composite combining polydimethyl siloxane and polytetrafluoroethylene (PTFE).

The expression “ppm” as used herein means parts per million parts by weight of the polyester.

The following examples further illustrate this invention.

We prepared a series of polyethylene terephthalate bottles containing various levels of fumed silicon dioxide.

The following table shows the properties and operating conditions for the examples. The Example 1 is a prior art control and contains no silicon dioxide. Examples 2 and 3 contain 20 ppm and 100 ppm of fumed silicon dioxide respectively. Examples 2 and 3 also contain 4 ppm of carbon black.

TABLE 1

| | | Prior Art | | |
|---|---|---|---|---|
| | | Control | | |
| S.N. | Properties | Example 1 | Example 2 | Example 3 |
| 1 | Melt temp. (° C.) | 267 | 265 | 263 |
| | during extrusion | | | |
| 2 | I.V drop (dl/g) | −0.055 | −0.048 | −0.047 |
| | from dried chips to | | | |
| | preform | | | |
| 3 | Acetaldehyde | +1.94 | +1.87 | +1.75 |
| | level (ppm) to | | | |
| | preform | | | |
| 4 | Heater output (%) | 91 | 83 | 82 |
| | of the blowing | | | |
| | machine to | | | |
| | produce bottles at | | | |
| | a constant speed | | | |
| | of @ 925 | | | |
| | bottles/hr. | | | |
| 5 | Heater output (%) | Not | 102 | 100 |
| | of the blowing | possible to | | |
| | machine to | blow at all | | |
| | produce bottles at | | | |
| | a constant speed | | | |
| | of @ 1200 | | | |
| | bottle/hr. | | | |

The data show:

(a) Lower drop in I.V.

(b) Lower generation of acetaldehyde.

(c) Action of fumed silicon dioxide in synergy with carbon black during heating and blowing of preform into bottles whereby the productivity is enhanced with respect to control Example 1 at lower heat output at any one constant speed (for example at 925 bottles/hr and at 1200 bottles/hr.

The above three examples, which were synthesized in the laboratory, were also analyzed by Quantitative Near Infrared (NIR spectroscopy. I found out that Examples 2 and 3 were having around 8% to 13% higher heat absorption capacity over Example 1, which did not have any additives (see Table III).

| | | | Fraction energy | Energy absorbed |
|---|---|---|---|---|
| | | thickness | absorbed in NIR | relative to first |
| S.N. | Sample | (nm) | range | sample |
| 1 | Example-1 | 0.1016 | 0.23 | 1.0 |
| | Prior Art | | | |
| 2 | Example-2 | 0.1016 | 0.25 | 1.087 |
| 3 | Example-3 | 0.1016 | 0.26 | 1.130 |

All three recipes were injection molded into preforms (2 liter bottle: 48±0.5 gm) and blown into bottles. The I.V. drop from dried chips to preforms and level of acetaldehyde in preform was determined. The bottles were blown at two blowing speeds. When silicon dioxide is an added in concentration from 0 to 5000 ppm. there is less drop in I.V. in polyester resin in the process of preforms production process. Also, there is less level of acetaldehyde in such resultant preforms. Additionally, the fumed silicon dioxide does not effect the strain-hardening in blowing operation from preform to bottles. This leads to material saving while achieving the same mechanical strength despite less weight of bottles.

Although the now preferred embodiments of the invention have been set forth, it will be apparent to those skilled in the art that various changes and modifications may be made thereto without departing from the spirit and scope of the invention as set forth in the following claims.

I claim:

1. A low intrinsic viscosity drop, low acetaldehyde, polyester composition having a low drop in intrinsic viscosity and a low acetaldehyde level wherein the polyester composition contains an amount of an additive of fumed silicon dioxide ranging from 10 to less than 100 ppm, the additive having a particle size ranging from 0.1 to 0.2 micron.

2. A polyester composition according to claim 1 wherein the particle size ranges from greater than 0.1 to less than 0.2 micron.

3. A polyester composition according claim 1 wherein the amount of additive ranges from greater than 10 to less than 100 ppm.

4. A polyester composition according to claim 3 wherein the amount of additive ranges from 50 to less than 100 ppm.

5. A polyester composition according to claim 1 wherein the polyester composition contains 20 ppm of silicon dioxide.

6. A polyester composition according to claim 1 wherein the additive is a powder.

7. A polyester composition according to claim 1 wherein the additive is amorphous powder.

8. A polyester composition according to claim 1 containing a small amount of at least one infrared absorbing material.

9. A polyester composition according to claim 8 wherein the infrared absorbing material is carbon black.

10. A polyester composition according to claim 8 wherein the amount of infrared absorbing material ranges from 0.1 to 10 ppm.

11. A polyester composition according to claim 8 wherein the amount of infrared absorbing material ranges from 0.1 to 5 ppm.

12. A polyester composition according to claim 8 wherein the amount of infrared absorbing material is 4 ppm.

13. A polyester composition according to claim 8 wherein the infrared absorbing material has a particle size ranging from 10 to 500 nm.

14. A polyester composition according to claim 1 wherein the polyester is reaction product of a dicarboxylic acid having from 2 to 40 carbon atoms, or an ester thereof and a diol having from 2 to 20 carbon atoms.

15. A polyester composition according to claim 1 wherein the polyester is polyethylene terephthalate homopolymer/copolymer.

16. A polyester bottle preform comprising the polyester composition of claim 1.

17. A polyester molded bottle comprising the polyester composition of claim 1.

18. A process for producing a polyester composition having a low intrinsic viscosity drop and a low acetaldehyde level comprising the step of reacting at least one dicarboxylic acid or ester and at least one diol under condensation polymerization conditions and the step of adding an amount of an additive of fumed silicon dioxide during the reacting step wherein the amount of the additive ranges from 10 to less than 100 ppm, the additive having a particle size ranging from 0.1 to 0.2 micron.

19. A process according to claim 18 including the step of adding carbon black during the reacting step.

20. A process for producing a powdered polyester composition having a low intrinsic viscosity drop and a low acetaldehyde level comprising the step of making a powder from a reaction product of at least one dicarboxylic acid or ester and at least one diol and the step of adding an an amount of additive of fumed silicon dioxide during the powder making step wherein the amount of additive ranges from 10 to less than 100 ppm, the additive having a particle size ranging from 0.1 to 0.2 micron.

21. A process according to claim 20 including the step of adding carbon black during the powder making step.

22. A process for producing a polyester composition having a low intrinsic viscosity drop and a low acetaldehyde level comprising the step of making powders, pellets, cubes, chips or other small particle forms from a reaction product of at least one dicarboxylic acid or ester and at least one diol and the step of adding an amount of an additive of fumed silicon dioxide during the making step or any subsequent compounding step wherein the amount of the additive ranges from 10 to less than 100 ppm, the additive having a particle size ranging from 0.1 to 0.2 micron.

23. A process according to claim 22 including the step of adding carbon black during the making step or any subsequent compounding step.

24. A quick heating, biaxially oriented filing comprising the polyester composition of claim 1.

25. A film according to claim 24 wherein the polyester composition is PET.
